(19) United States
(12) Patent Application Publication
(10) Pub. No.: US 2024/0251067 A1
(43) Pub. Date: Jul. 25, 2024

(54) SELECTIVELY DOWNLOADING PORTIONS OF OBJECTS IN A VOLUMETRIC VIDEO BASED ON INTERNET BANDWIDTH AVAILABILITY

(71) Applicant: International Business Machines Corporation, Armonk, NY (US)

(72) Inventors: Sooraj Sukumar, Palakkad (IN); Shailendra Moyal, Pune (IN); Sarbajit K. Rakshit, Kolkata (IN)

(21) Appl. No.: 18/099,816

(22) Filed: Jan. 20, 2023

(51) Int. Cl. H04N 13/139; H04L 65/752; H04N 13/167; H04N 13/383

(52) U.S. Cl. CPC H04N 13/139; H04L 65/752; H04N 13/167; H04N 13/383

(57) ABSTRACT

A computer-implemented method, according to one embodiment, includes monitoring eye movement of a user while the user navigates a volumetric video displayed on a user device, and comparing an internet bandwidth associated with the user device to a threshold. In response to a determination that the internet bandwidth is less than the threshold, the method includes determining, for first objects in a first view of the volumetric video, first portions of the first objects that are not visible in the first view and second portions of the first objects that are visible in the first view, and not downloading the first portions. Furthermore, in response to the determination, the method includes causing the second portions to be downloaded, determining levels of resolution, and causing the second portions, each having a respective one of the determined levels of resolution, to be incorporated into the volumetric video.

### BACKGROUND

The present invention relates to volumetric video, and more specifically, this invention relates to selectively downloading portions of objects in a volumetric video based on available internet bandwidth.

Volumetric video technology leverages cameras and advanced data processing to render 3D images from a virtual space. More specifically, a volumetric video is produced by processing feeds from multiple cameras from various direction to create a volume of video. Furthermore, in order to create the volumetric video, computing processors may process multiple image feeds from different directions and create volumetric video. This allows for video point of views to be generated from any angle within that space to create a more immersive experience for viewers. For example, using volumetric video, a user can view media from various directions, e.g., using a virtual reality (VR) system, a three-dimensional (3D) display system or any two-dimensional (2D) display system.

Volumetric videos are useful for businesses, small and large, in that volumetric video establishes unique ways of collaborating, e.g., such as by enabling virtual offices to be created.

### SUMMARY

A computer-implemented method, according to one embodiment, includes monitoring eye movement of a user while the user navigates a volumetric video displayed on a user device, to establish historical data, and comparing an internet bandwidth associated with the user device to a predetermined threshold. In response to a determination that the internet bandwidth is less than the predetermined threshold, the method includes determining, for first objects in a first view of the volumetric video, first portions of the first objects that are not visible in the first view and second portions of the first objects that are visible in the first view, and causing the first portions of the first objects to be not downloaded. Furthermore, in response to a determination that the internet bandwidth is less than the predetermined threshold, the method includes causing the second portions of the first objects to be downloaded, determining, based on the historical data, levels of resolution to incorporate into the second portions in the volumetric video, and causing the second portions, each having a respective one of the determined levels of resolution, to be incorporated into the volumetric video.

A computer program product, according to another embodiment, includes a computer readable storage medium having program instructions embodied therewith. The program instructions are readable and/or executable by a computer to cause the computer to perform the foregoing method.

A system, according to another embodiment, includes a processor, and logic integrated with the processor, executable by the processor, or integrated with and executable by the processor. The logic is configured to perform the foregoing method.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one embodiment of the present invention.

FIG. 2 is a flowchart of a method, in accordance with one embodiment of the present invention.

FIG. 3 is a representation of a volumetric video, in accordance with one embodiment of the present invention.

FIGS. 4A-4B depict representations of an object of a volumetric video, in accordance with one embodiment of the present invention.

FIGS. 5A-5B depict representations of an object of a volumetric video, in accordance with one embodiment of the present invention.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred embodiments of systems, methods and computer program products for selectively downloading portions of objects in a volumetric video based on available internet bandwidth.

In one general embodiment, a computer-implemented method includes monitoring eye movement of a user while the user navigates a volumetric video displayed on a user device, to establish historical data, and comparing an internet bandwidth associated with the user device to a predetermined threshold. In response to a determination that the internet bandwidth is less than the predetermined threshold, the method includes determining, for first objects in a first view of the volumetric video, first portions of the first objects that are not visible in the first view and second portions of the first objects that are visible in the first view, and causing the first portions of the first objects to be not downloaded. Furthermore, in response to a determination that the internet bandwidth is less than the predetermined threshold, the method includes causing the second portions of the first objects to be downloaded, determining, based on the historical data, levels of resolution to incorporate into the second portions in the volumetric video, and causing the second portions, each having a respective one of the determined levels of resolution, to be incorporated into the volumetric video.

In another general embodiment, a computer program product includes a computer readable storage medium having program instructions embodied therewith. The program instructions are readable and/or executable by a computer to cause the computer to perform the foregoing method.

In another general embodiment, a system includes a processor, and logic integrated with the processor, executable by the processor, or integrated with and executable by the processor. The logic is configured to perform the foregoing method.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as selective object portion download determination module of block 150 for selectively downloading portions of objects in a volumetric video based on available internet bandwidth. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

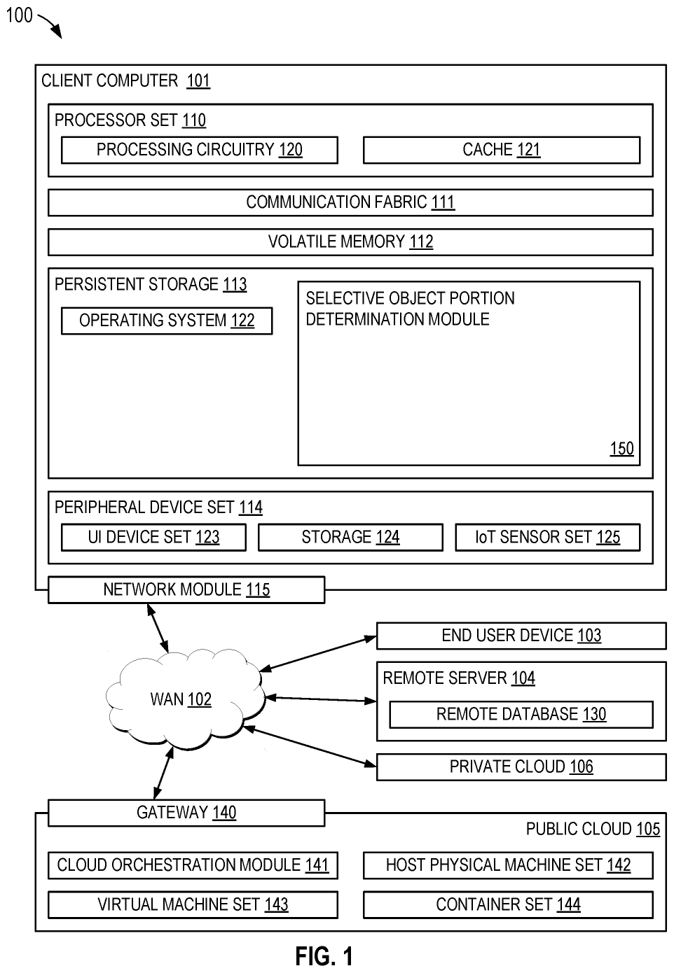

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

In some aspects, a system, according to various embodiments, may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various embodiments.

As mentioned elsewhere herein, volumetric video technology leverages cameras and advanced data processing to render 3D images from a virtual space. More specifically, a volumetric video is produced by processing feeds from multiple cameras from various directions to create a volume of video. Furthermore, in order to create the volumetric video, computing processors may process multiple image feeds from different directions and create volumetric video. This allows for a video point of view to be generated from any angle within that space to create a more immersive experience for viewers. For example, using volumetric video, a user can view media from various directions, e.g., using a virtual reality (VR) system, a three-dimensional (3D) display system or any two-dimensional (2D) display system.

Volumetric videos are useful for businesses, small and large, in that volumetric video establishes unique ways of collaborating, e.g., such as by enabling virtual offices to be created.

While navigating volumetric video with a VR device, a user can perform mobility around the volumetric video surrounding. This way, with virtual mobility, the user can reach any portion on the volumetric video and can also change a direction of view. However, volumetric video quality is impacted as a result of being watched in relatively low internet bandwidth networks. As a result, the user's level of experience on volumetric video becomes poor. Accordingly, there is a need for techniques that, in any bandwidth network, can optimize a viewing experience and image quality of a volumetric video.

In sharp contrast to the deficiencies of the conventional approaches described above, embodiments and approaches described herein include selectively downloading portions of objects in a volumetric video based on available internet bandwidth within a network.

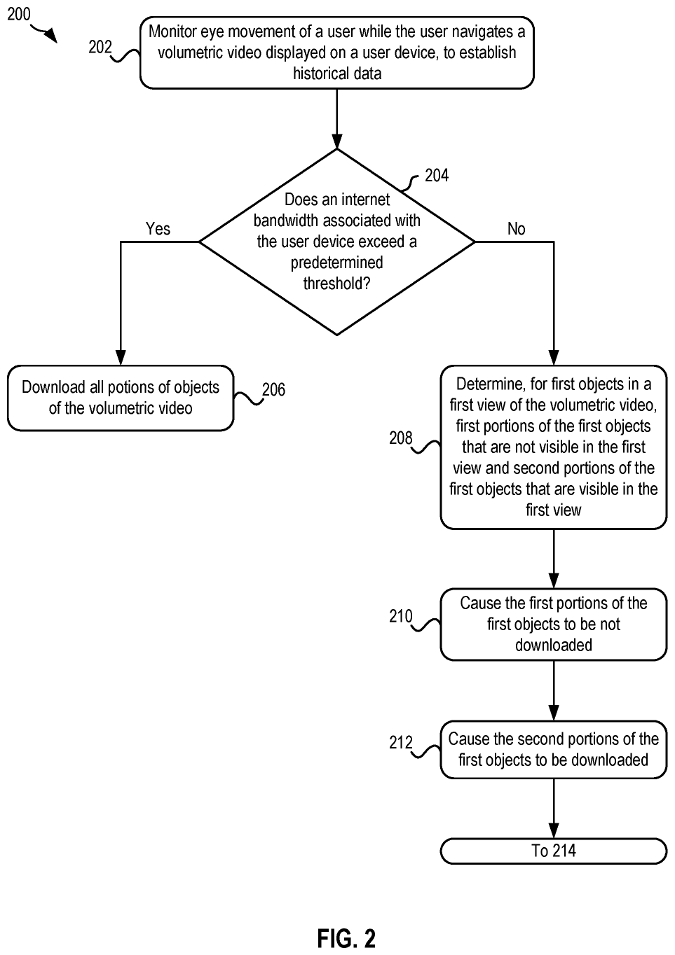

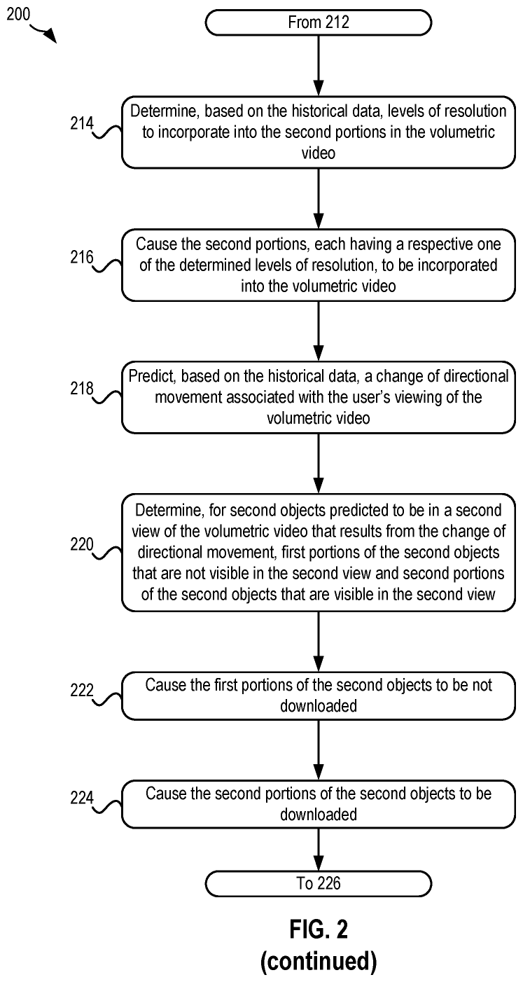

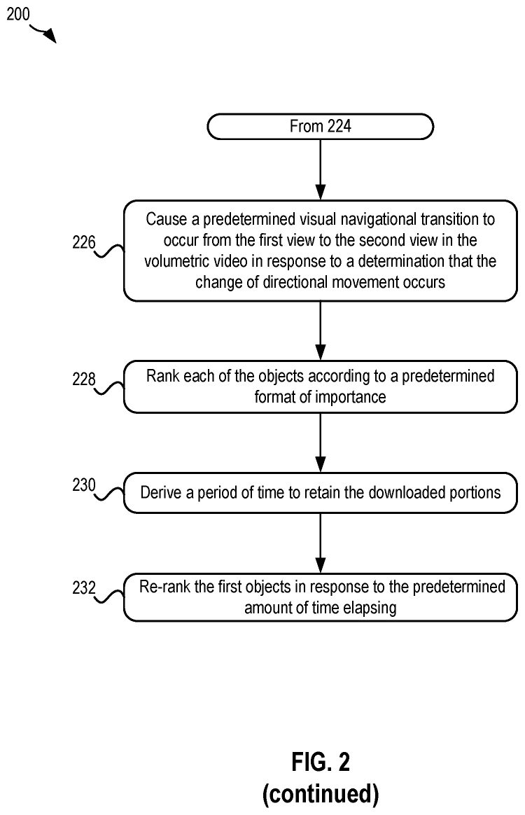

Now referring to FIG. 2, a flowchart of a method 200 is shown, according to one embodiment. The method 200 may be performed in accordance with the present invention in any of the environments depicted in FIGS. 1-5B, among others, in various embodiments. Of course, more or fewer operations than those specifically described in FIG. 2 may be included in method 200, as would be understood by one of skill in the art upon reading the present descriptions.

Each of the steps of the method 200 may be performed by any suitable component of the operating environment. For example, in various embodiments, the method 200 may be partially or entirely performed by a computer, or some other device having one or more processors therein. The processor, e.g., processing circuit(s), chip(s), and/or module(s) implemented in hardware and/or software, and preferably having at least one hardware component may be utilized in any device to perform one or more steps of the method 200. Illustrative processors include, but are not limited to, a central processing unit (CPU), an application specific integrated circuit (ASIC), a field programmable gate array (FPGA), etc., combinations thereof, or any other suitable computing device known in the art.

Operation 202 includes monitoring eye movement of a user while the user navigates a volumetric video displayed on a user device, to establish historical data. It should be prefaced, that all monitoring of users described herein is preferably performed subsequent to being granted permission to do so, e.g., a user opt-in. The user device may include any type of user device for viewing a volumetric video that would become apparent to one of ordinary skill in the art upon reading the descriptions herein. For example, a non-limiting list of such user devices may include, e.g., an AR viewing device such as AR glasses, a device display, virtual reality (VR) glasses, a front facing camera device with a display component, a projector with at least one user input and/or control component, etc. Furthermore, the user device preferably includes at least one component and/or is paired with at least one component that allows the user to input requests for navigating the volumetric video, e.g., a microphone, a computer mouse, a known type of eye-tracking component, a keyboard, a remote controller, a console controller, etc. Based on historical learning from the monitoring and historical data generated as a result, factors such as eye movement patterns of the user, speed of eye movement patterns of the user, speed of change in a direction of viewing of the user, etc., may be determined. These factors may be used to make one or more of the determinations described elsewhere below.

In some approaches, the user's navigation of the volumetric video may be defined as user narrated changes of perspective within the volumetric video. During this navigation, the user's perspective within the volumetric video (hereafter referred to as “views”, e.g., such as a first view, a second view, a third view, etc.) may change, and is identified to determine a direction of viewing within the volumetric video. These views may, in some approaches, be three-dimensional perspectives within the volumetric video from a reference point that is determined, based on input received from the user, by a device that is performing method 200. This way, the views of objects within the volumetric video may be adjusted to view different portions and/or sides of the objects. Note that, in some approaches, at least some of the objects of the volumetric video may include, e.g., humans, animals, animated characters, plants, trees, statues, geographical landmarks, nature, etc.

In some approaches, in response to determining that a change of directional movement associated with the user's viewing of the volumetric video has occurred, e.g., as a result of a user control receiving input from the user to navigate from a first view of the volumetric video, a transition to a second view of the volumetric video may be output to a display of the user device. In some approaches, predetermined information metrics, e.g., objects focused on by the user, eye movement, received navigation commands, time spent at each of the different views, etc., may be obtained as a result of performing the monitoring of the user's eye movement. This information may be stored, e.g., in a predetermined table of a predetermined database, to establish the historical data. As will be described elsewhere herein, this historical data may be used to determine how to adjust views of the volumetric video in order to refine the user's viewing experience of the volumetric video.

An internet bandwidth associated with, e.g., available to, used by, etc., the user device may be considered, in some approaches, in order to determine how to refine the user's viewing experience with the volumetric video. More specifically, in one or more of such approaches, the internet bandwidth associated with the user device may be considered to determine whether the volumetric video includes contents that are not able to be fully downloaded and displayed by the user device based on a signal strength of the internet bandwidth, and thereby introduces latency into the volumetric video. For context, latency being introduced into a volumetric video deteriorates a viewing experience of a user that is viewing a volumetric video. Accordingly, it in some approaches, the internet bandwidth associated with the user device may be compared to a predetermined threshold, e.g., see decision 204. For context, the predetermined threshold is, in some approaches, a minimum amount of internet bandwidth that is required to download all portions and/or sides of the objects of the volumetric video without latency being incorporated into the volumetric video. Comparison techniques that would become appreciated by one of ordinary skill in the art upon reading the descriptions herein may be used. The predetermined threshold may be any predetermined threshold of internet bandwidth. A value of the predetermined threshold may be refined over time, e.g., such as in response to a determination that a change in the internet bandwidth associated with the user devices changes, in order to ensure that the predetermined threshold is one that ensures that latency associated with internet bandwidth is prevented from being introduced into the volumetric video.

In response to a determination that the internet bandwidth associated with the user device exceeds the predetermined threshold, e.g., as illustrated by the “Yes” logical path of decision 204, all portions and/or sides of objects of the volumetric video may be downloaded, e.g., see operation 206. Note that in some approaches in which the operations of method 200 are being performed by a device other than the user device, operation 206 may include causing, e.g., instructing all the portions and/or sides of the objects of the volumetric video to be downloaded by the user device. Note that, all of the portions and/or sides that are downloaded include portions and/or sides of objects of the volumetric video that are not visible in one or more views of the video that are being displayed on the user device. For example, assuming that in a first frame of the volumetric video, first portions of an object are not visible, e.g., to the user, on the display, in a perspective of the volumetric associated with the first view, etc., and second portions of the object are visible. In response to a determination that the internet bandwidth associated with the user device exceeds, or is equal to, in some approaches, the predetermined threshold, the first portions and the second portions of the objects are downloaded. For context, the first portions and the second portions of the objects are downloaded in response to the determination that the internet bandwidth associated with the user device exceeds, or is equal to, in some approaches, the predetermined threshold, because the internet bandwidth associated with the user device can afford to perform such an extent of downloading without latency being introduced into the volumetric video. In contrast, various operations will now be described below which may be performed in response to a determination that the internet bandwidth associated with the user device does not exceed the predetermined threshold, to thereby prevent latency from being introduced into the volumetric video.

In response to a determination that the internet bandwidth associated with the user device is less than the predetermined threshold, e.g., as illustrated by the “No” logical path of decision 204, the method optionally continues to operation 208. Operation 208 includes, determining, for first uniquely identified objects in a first view of the volumetric video, first portions and/or sides of the first objects that are not visible in the first view and second portions and/or sides of the first objects that are visible in the first view. In some approaches, the first view is a current viewing perspective, e.g., a view that is currently being displayed on the display of the user device. In some other approaches, the first view is a viewing perspective that is scheduled to be output to and/or downloaded on and/or displayed on a display of the user device. In order to download portions of the objects, and in doing so, not exceed a potential of the internet bandwidth, the first portions of the first objects are caused, e.g., via a command and/or instruction, to be not downloaded, and the second portions of the first objects are caused to be downloaded, e.g., see operation 210 and operation 212. Accordingly, selective downloading is performed in some approaches. As a result of selectively downloading only object portions and/or sides that are visible in the volumetric video, internet bandwidth is preserved, thereby relatively reducing and/or mitigating latency within the volumetric video that is displayed on the user device. For a number of reasons, this also results in relatively less processing being performed on a computer device than would otherwise be performed without performing such selective downloading. For example, this results in a reduction in an extent of downloading that is performed by a computer device. Furthermore, this results in a relative reduction in known types of latency reduction procedures and/or operations being performed, which would be performed if the latency was otherwise not prevented from being incorporated into the volumetric video. Selectively downloading portions of objects in a volumetric video has heretofore not been considered when accounting for available internet bandwidth. Instead, in conventional use cases, user devices that only have access to relatively limited internet bandwidths attempt to download all contents of a volumetric video, and thereby incorporate latency into the volumetric video. Accordingly, the inventive discoveries disclosed herein with regards to use of selectively downloading portions of objects in a volumetric video and/or determining levels of resolution to incorporate into portions of the volumetric video that are downloaded (see operation 214), proceed contrary to conventional wisdom.

Another technique for accounting for the internet bandwidth associated with the user device being less than the predetermined threshold includes determining levels of resolution to incorporate into portions of the volumetric video that are downloaded, before the portions are displayed on the display of the user device. Note that depending on the approach, such a resolution technique may be performed in addition to or as an alternative to selectively downloading portions of the objects in the volumetric video. Operation 214 includes, determining, based on the historical data, levels of resolution to incorporate into the second portions in the volumetric video. In some approaches, target objects are identified, which are assigned relatively higher levels of resolution, e.g., a first predetermined level of resolution, than non-target objects which are identified and assigned relatively lower levels of resolution, e.g., a second predetermined level of resolution. Note that, in some approaches, resolution may be based on latency being incorporated into and/or corrected out of the portions. For example, in response to a determination that a spectator in a crowd is not a target object, a resolution of the spectator may be assigned to relatively low to prevent latency from being experienced in a rendering of target objects in the volumetric video, e.g., based on limited internet bandwidth being available. In some approaches, target objects are identified from the historical data, and are objects that the user is determined to focus relatively more on, e.g., relatively more frequently, for relatively longer periods of time, etc. This may be determined from the historical data, and more specifically, data that is based on a determined eye direction of the user and field of view (FoV) information from any relative location within the volumetric video. In contrast, in some approaches, non-target objects may additionally and/or alternatively be identified from the historical data, and are objects that the user is determined to focus relatively less on, e.g., relatively less frequently, for relatively shorter periods of time, not look at in one or more views of the volumetric video, etc. Eye focus distance may also be considered and used in order to determine target objects and/or a resolution that should be assigned to an object. For example, objects that the user historically tends to view at a relatively closer eye focus distance, e.g., while relatively zoomed in, may be determined to be target objects and/or assigned relatively higher resolution. In some approaches, eye tracking techniques that would become appreciated by one of ordinary skill in the art upon reading the descriptions herein may be used to determine such target objects. Portions of the historical data that correspond to such eye tracking, may additionally and/or alternatively be used to make such a determination. Note that, in some approaches in which a determination is made that the internet bandwidth exceeds the predetermined threshold, levels of resolution of the object is not limited, e.g., the objects are caused to have full resolution in the volumetric video.

Operation 216 includes causing the second portions, each having a respective one of the determined levels of resolution, to be incorporated into the volumetric video and/or delivered to a predetermined volumetric video delivery system. For example, this incorporation may include outputting an updated version and/or frame(s) of the volumetric video for display on the user device. Note that, the first portions of the first objects are not incorporated into the volumetric video based on not being downloaded.

Note that this is an ongoing process in that a current view of the volumetric video may change at any time, e.g., such as in response to receiving a request from a user input to change views of the volumetric video. Various approaches described below detail operations for ongoingly determining contents to download and levels of resolution to incorporate into the volumetric video.

Operation 218 includes predicting, based on the historical data, a change of directional movement associated with the user's viewing of the volumetric video. For context, a definition of the term “directional movement” may depend on the approach, but generally refers to a change that may update a perspective of objects of the volumetric video and/or focus of the user with respect to the volumetric video. For example, in some approaches, the directional movement associated with the user's viewing of the volumetric video may be based on at least some of the first objects in the video moving, e.g., rotating, turning, moving in or out of frame, coming closer to the view or further from the viewer, changing color, etc. For example, in one of such approaches, the directional movement of at least some of the first objects may be such that one or more of the second portions of the first objects become no longer visible, e.g., in the first view. In another approach, at least some of the first objects in the video moving may be such that one or more of the first portions of the first objects become visible, e.g., in the first view. In some other approaches, a change of the directional movement may be predicted in response to a determination that the user has input a command associated with changing from the first view to the second view of the volumetric video, e.g., input on a game controller, audio commands, typed commands, etc. In yet another approach, the directional movement associated with the user's viewing of the volumetric video may be based on a determination that a change in a focus of the user has occurred. For example, it may be determined from the historical data that the user has shifted eye focus with respect to an object in the first view, e.g., such as where a new target device is established based on a focus time and/or frequency on an object that was not previously considered a target device.

Operation 220 includes determining, for second objects predicted to be in a second view of the volumetric video that results from the change of directional movement, first portions and/or sides of the second objects that are predicted to be not visible, e.g., to the user in the second view. Furthermore, second portions and/or sides of the second objects that are predicted to be visible to the user in the second view may be determined. In some approaches, the second objects may be objects that are visible in what is predicted to be the second view of the volumetric video. For example, in some approaches, a navigational path throughout the volumetric video may, in some approaches, be used to determine what will be the second view of the volumetric video, e.g., where a current directional navigation in the volumetric video points toward the second view. In some other approaches, the historical data may additionally and/or alternatively be considered to determine what the second view of the volumetric video will be, e.g., using prediction models that are based on previously navigated to views (determined navigation patterns determined from the historical data) of the volumetric video. Method 200 includes causing the first portions of the second objects to be not downloaded, e.g., see operation 222, and causing the second portions of the second objects to be downloaded, e.g., see operation 224.

It should be noted that the second objects described above are different than the first objects, e.g., different people, different animals, etc. However, in some approaches, the first objects, or at least portions thereof, may be predicted to be visible in the second view of the volumetric video. In one or more of such approaches, method 200 may optionally include determining, for the first objects predicted to be in the second view of the volumetric video, third portions and/or sides of the first objects that are predicted to be not visible, e.g., to the user, in the second view. Fourth portions and/or sides of the first objects that are predicted to be visible in the second view may additionally and/or alternatively be determined. Note that these third portions and fourth portions are different than the first portions and the second portions of the first objects. Method 200 optionally includes causing the third portions of the first objects to be not downloaded and causing the fourth portions of the first objects to be downloaded, e.g., in response to the previous determination that the internet bandwidth is less than the predetermined threshold and/or in response to a determination that the internet bandwidth is still less than the predetermined threshold.

In some approaches, a second view of the volumetric video may be displayed on a display of the user device in the event that the predicted directional movement, or some other directional movement, actually occurs. The first view and the second view may, in some approaches, be three-dimensional (3D) perspectives within the volumetric video. In some approaches, method 200 may include causing a predetermined visual navigational transition to occur from the first view to the second view in the volumetric video in response to a determination that the change of directional movement occurs, e.g., see operation 226. For example, in one approach, the predetermined visual navigational transition may include a perspective of flying and/or gliding from the first view to the second view within the volumetric video. According to a more specific example, assuming that a first view of the volumetric video is a perspective of watching a basketball from a club box far above the court, a predetermined visual navigational transition may give the visual perception of gliding down to a courtside seat associated with a second view of the volumetric video. In some approaches, the visual navigational transition may allow a perspective of passing through objects that are located along a path between the first and second view in the volumetric video. In some other approaches, in response to a determination that a user control input, e.g., inputs on a game controller, cause a perspective to come across objects while transitioning along a path between the first and second view in the volumetric video, the perspective may reset to the first view of the volumetric video.

In some approaches, the downloaded portions of the objects may be ranked. For example, method 200 may include ranking each of the first objects according to a predetermined format of importance, e.g., see operation 228. In one approach, the format of importance may be based on the historical data. For example, objects that have been relatively more focused on by the user may be assigned relatively higher rankings and objects that have been relatively less focused on by the user may be assigned relatively lower rankings. In another approach, the predetermined format of importance may assign objects that have relatively more movement within the volumetric video relatively higher rankings and objects that have relatively less movement within the volumetric video may be assigned relatively lower rankings. In another approach, the predetermined format of importance may assign objects that emit relatively more sound within the volumetric video relatively higher rankings and objects that have relatively less sound within the volumetric video may be assigned relatively lower rankings. The format is, in some preferred approaches, configured to cause relatively higher levels of resolution to be incorporated into the second portions of first objects having relatively higher rankings, and the format may be configured to cause relatively lower levels of resolution to be incorporated into the second portions of first objects having relatively lower rankings.

The downloaded portions of the objects may, in some optional approaches, only be maintained for a predetermined amount of time. For example, in some approaches, the VR devices are caused to store the downloaded objects in frames for a predetermined amount of time. This way, in response to a determination that a video navigation is to show the same frames of the volumetric video again, instead of downloading the objects and/or frame again, they are stored for future uses based on user viewing area at present user location. Accordingly, in some approaches, method 200 includes deriving, e.g., see operation 230, a period of time, e.g., one hour, one day, one week, etc., to retain the downloaded portions, e.g., such as the downloaded second portions. In response to the determination that the predetermined amount of time has elapsed, the ranked objects may be re-ranked, e.g., see operation 232. For example, in some approaches, the first objects that were previously ranked may be re-ranked to determine, e.g., whether to dispose of the download, to determine a relative level of resolution for the first objects, to determine whether to maintain the downloads, etc. This may free-up memory that would otherwise be used for storing downloads that are no longer relevant, e.g., downloads that are initially ranked relatively higher than a ranking that the downloads are assigned subsequent to the re-ranking being performed.

FIG. 3 depicts a representation 300 of a volumetric video, in accordance with one embodiment. As an option, the present representation 300 may be implemented in conjunction with features from any other embodiment listed herein, such as those described with reference to the other FIGS. Of course, however, such representation 300 and others presented herein may be used in various applications and/or in permutations which may or may not be specifically described in the illustrative embodiments listed herein. Further, the representation 300 presented herein may be used in any desired environment.

The representation 300 depicts a volumetric video 302 that includes two objects, e.g., see a first object 304 and a second object 306, which are two people playing basketball with one another. A first view 308 of the volumetric video 302 is seen by a user 310 in a display of a user device 312 worn by the user 310. Portions and/or sides of the objects 304, 306 are determined and caused to be downloaded in response to a determination that an internet bandwidth associated with the user device 312 is less than a predetermined threshold.

One or more portions and/or sides of the objects may not be downloaded, at least while the user views the volumetric video from the first view, in response to the determination that the internet bandwidth associated with the user device is less than a predetermined threshold. For example, portions of the objects that are otherwise visible in a second view 314 of the volumetric video, but that are not visible in the first view of the volumetric video are not downloaded in response to the determination that the internet bandwidth associated with the user device is less than the predetermined threshold. This way, network bandwidth usage may be optimized. One or more other factors, e.g., focus distance, context of volumetric video navigation, etc., may be used to determine portions of the objects that are not downloaded. For example, within a contextual situation of a volumetric video that includes a basketball game, it may be determined, e.g., realized, that the players of the game will be traveling back and forth on the court for the entire game in the volumetric video. This context may be used to identify a first team, e.g., offensive team, that may be facing a first direction on a first side of the court, and a second team, e.g., a defensive team, that may be facing an opposite direction on the first side of the court. This context may also be determined to reveal that opposite sides of each of the teams may be predicted to be visible when possession of the ball switches teams, e.g., the offensive team then plays defense, and the defensive team then plays offense as a result of the change of possession. Furthermore, in some approaches, levels of resolution to be incorporated into the downloaded portions and/or portions that are scheduled to be downloaded in the volumetric video may be determined. In some approaches, these levels may be determined based on historical data that is established as a result of monitoring the eye movement of the user while the user navigates the volumetric video displayed on the user device. The portions, each having a respective one of the determined levels of resolution, may be caused to be incorporated into the volumetric video. This way, at least some portions are caused to have relatively lower portions than other portions so that with the available network bandwidth, the user can properly view the volumetric video.

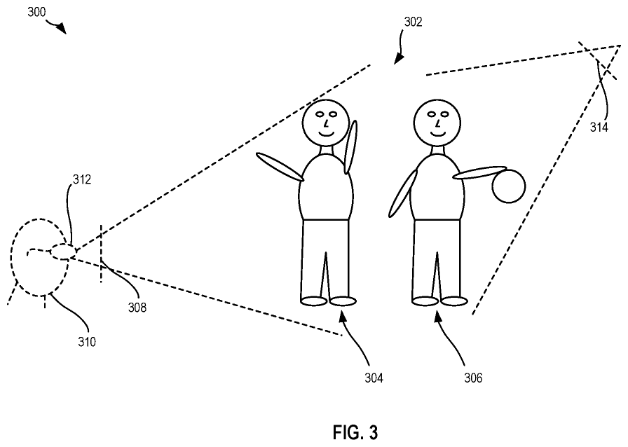

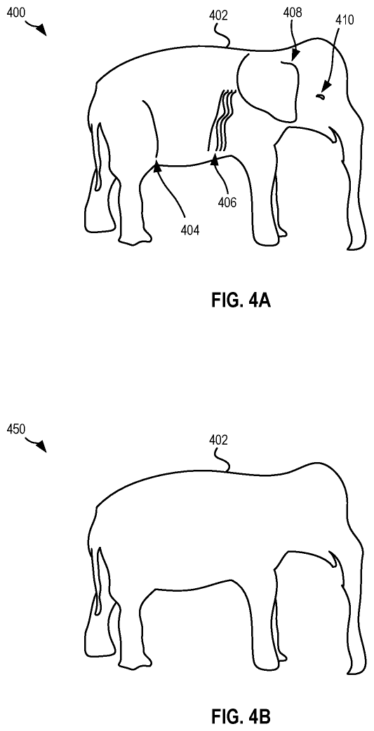

FIGS. 4A-4B depict representations 400, 450 of an object of a volumetric video, in accordance with one embodiment. As an option, the present representations 400, 450 may be implemented in conjunction with features from any other embodiment listed herein, such as those described with reference to the other FIGS. Of course, however, such representations 400, 450 and others presented herein may be used in various applications and/or in permutations which may or may not be specifically described in the illustrative embodiments listed herein. Further, the representations 400, 450 presented herein may be used in any desired environment.

Referring first to representation 400 of FIG. 4A, an object 402, which is an elephant of a volumetric video, may be downloaded based on the side perspective of the object 402 being included in a view of the volumetric video, e.g., where the view is a current viewing direction of a user of the volumetric video and thereby aligned with an eye focus direction of the user. More specifically, it should be noted that portions of the object 402 are downloaded, e.g., see curvature 404, wrinkles 406, ear 408 and eye 410. These portions that are visible in the view of the volumetric video may, in some approaches, be downloaded in response to a determination that an internet bandwidth associated with a user device is less than a predetermined threshold.

Referring now to representation 450 of FIG. 4B, portions of the object 402 are not downloaded based on the side perspective of the object 402 shown in FIG. 4B not being visible in the view of the volumetric video described in FIG. 4A. Accordingly, a second view of the volumetric video show in FIG. 4B is not a current viewing direction of the user of the volumetric video and thereby does not align with the current eye focus direction of the user. For this reason, the portions of the object 402 otherwise downloaded in FIG. 4A are not downloaded in FIG. 4B, e.g., in order to reduce internet bandwidth usage and thereby prevent latency from being incorporated into the volumetric video displayed on the user device.

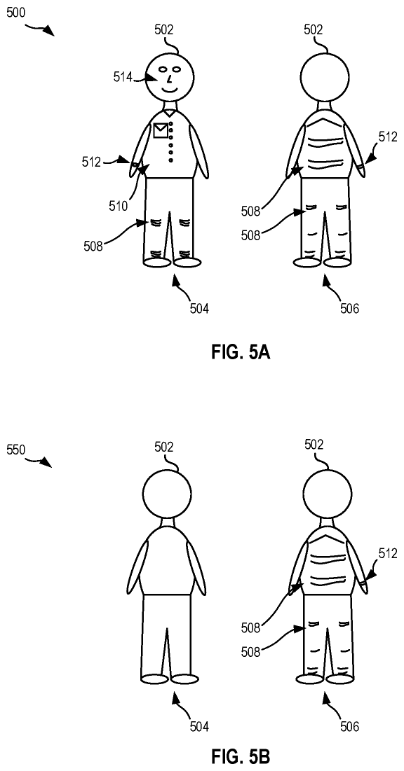

FIGS. 5A-5B depict representations 500, 550 of an object of a volumetric video, in accordance with one embodiment. As an option, the present representations 500, 550 may be implemented in conjunction with features from any other embodiment listed herein, such as those described with reference to the other FIGS. Of course, however, such representations 500, 550 and others presented herein may be used in various applications and/or in permutations which may or may not be specifically described in the illustrative embodiments listed herein. Further, the representations 500, 550 presented herein may be used in any desired environment.

Referring first to FIG. 5A, representation 500 illustrates a front side 504 and a back side 506 of an object 502, e.g., a human, of the volumetric video. It may be assumed that it has been determined that an internet bandwidth associated with a user device is greater than or equal to a predetermined threshold. Accordingly, in representation 500, all of the portions of the object have been caused to be downloaded, e.g., an entire 3D object is downloaded that includes all sides of the object 502. It may be noted that portions of the objects are also downloaded including, e.g., clothing wrinkles 508, shirt buttons and a pocket 510, a watch 512, and facial features 514.

Referring now to FIG. 5B, representation 550 illustrates that in a relatively low bandwidth geographical location, in some approaches, some portions of an object are not downloaded in order to relatively reduce latency in a volumetric video. In some approaches, only a contour of the object is instead downloaded, e.g., see FIG. 4B and FIG. 5B. For example, portions of the front side of the object 502 are not downloaded in FIG. 5B in response to a determination that an internet bandwidth associated with the user device is less than the predetermined threshold. It may be assumed that the back side 506 of the user is visible in a current view of the volumetric video, and therefore, portions of the backside have been downloaded, e.g., see clothing wrinkles 508 in the back side 506 of the user.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
monitoring eye movement of a user while the user navigates a volumetric video displayed on a user device, to establish historical data;
comparing an internet bandwidth associated with the user device to a predetermined threshold; and
in response to a determination that the internet bandwidth is less than the predetermined threshold:
determining, for first objects in a first view of the volumetric video, first portions of the first objects that are not visible in the first view and second portions of the first objects that are visible in the first view,
causing the first portions of the first objects to be not downloaded,
causing the second portions of the first objects to be downloaded,
determining, based on the historical data, levels of resolution to incorporate into the second portions in the volumetric video, and
causing the second portions, each having a respective one of the determined levels of resolution, to be incorporated into the volumetric video.

2. The computer-implemented method of claim 1, comprising, in response to determining that the internet bandwidth is less than the predetermined threshold: predicting, based on the historical data, a change of directional movement associated with the user's viewing of the volumetric video; determining, for second objects predicted to be in a second view of the volumetric video that results from the change of directional movement, first portions of the second objects that are not visible in the second view and second portions of the second objects that are visible in the second view; causing the first portions of the second objects to be not downloaded; and causing the second portions of the second objects to be downloaded.

3. The computer-implemented method of claim 2, wherein the directional movement is selected from the group consisting of: at least some of the first objects in the video moving such that one or more of the second portions of the first objects become no longer visible, at least some of the first objects in the video moving such that one or more of the first portions of the first objects become visible, the user inputting a command associated with changing from the first view to the second view of the volumetric video, and a change in a focus of the user.

4. The computer-implemented method of claim 2, comprising, in response to determining that the internet bandwidth is less than the predetermined threshold: determining third portions of the first objects that are not visible in the second view and fourth portions of the first objects that are visible in the second view; causing the third portions of the first objects to be not downloaded; and causing the fourth portions of the first objects to be downloaded.

5. The computer-implemented method of claim 4, wherein the first view and the second view are three-dimensional perspectives within the volumetric video, and comprising: causing a predetermined visual navigational transition to occur from the first view to the second view in the volumetric video in response to a determination that the change of directional movement occurs.

6. The computer-implemented method of claim 1, comprising: ranking each of the first objects according to a predetermined format of importance, wherein the format is configured to cause relatively higher levels of resolution to be incorporated into the second portions of first objects having relatively higher rankings, wherein the format is configured to cause relatively lower levels of resolution to be incorporated into the second portions of first objects having relatively lower rankings; deriving a period of time to retain the downloaded second portions; and in response to the predetermined amount of time elapsing, re-ranking the first objects.

7. The computer-implemented method of claim 1, wherein the objects are selected from the group consisting of: humans, animals, and animated characters.

8. The computer-implemented method of claim 1, comprising: in response to a determination that the internet bandwidth is greater than the predetermined threshold, causing the first portions and the second portions of the first objects to be downloaded.

9. A computer program product, the computer program product comprising a computer readable storage medium having program instructions embodied therewith, the program instructions readable and/or executable by a computer to cause the computer to:
monitor, by the computer, eye movement of a user while the user navigates a volumetric video displayed on a user device, to establish historical data;
compare, by the computer, an internet bandwidth associated with the user device to a predetermined threshold; and
in response to a determination that the internet bandwidth is less than the predetermined threshold:
determine, by the computer, for first objects in a first view of the volumetric video, first portions of the first objects that are not visible in the first view and second portions of the first objects that are visible in the first view,
cause, by the computer, the first portions of the first objects to be not downloaded,
cause, by the computer, the second portions of the first objects to be downloaded,
determine, by the computer, based on the historical data, levels of resolution to incorporate into the second portions in the volumetric video, and
cause, by the computer, the second portions, each having a respective one of the determined levels of resolution, to be incorporated into the volumetric video.

10. The computer program product of claim 9, the program instructions readable and/or executable by the computer to cause the computer to: in response to determining that the internet bandwidth is less than the predetermined threshold: predict, by the computer, based on the historical data, a change of directional movement associated with the user's viewing of the volumetric video; determine, by the computer, for second objects predicted to be in a second view of the volumetric video that results from the change of directional movement, first portions of the second objects that are not visible in the second view and second portions of the second objects that are visible in the second view; cause, by the computer, the first portions of the second objects to be not downloaded; and cause, by the computer, the second portions of the second objects to be downloaded.

11. The computer program product of claim 10, wherein the directional movement is selected from the group consisting of: at least some of the first objects in the video moving such that one or more of the second portions of the first objects become no longer visible, at least some of the first objects in the video moving such that one or more of the first portions of the first objects become visible, the user inputting a command associated with changing from the first view to the second view of the volumetric video, and a change in a focus of the user.

12. The computer program product of claim 10, the program instructions readable and/or executable by the computer to cause the computer to: in response to determining that the internet bandwidth is less than the predetermined threshold: determine, by the computer, third portions of the first objects that are not visible in the second view and fourth portions of the first objects that are visible in the second view; cause, by the computer, the third portions of the first objects to be not downloaded; and cause, by the computer, the fourth portions of the first objects to be downloaded.

13. The computer program product of claim 12, wherein the first view and the second view are three-dimensional perspectives within the volumetric video, and the program instructions readable and/or executable by the computer to cause the computer to: cause, by the computer, a predetermined visual navigational transition to occur from the first view to the second view in the volumetric video in response to a determination that the change of directional movement occurs.

14. The computer program product of claim 9, the program instructions readable and/or executable by the computer to cause the computer to: rank, by the computer, each of the first objects according to a predetermined format of importance, wherein the format is configured to cause relatively higher levels of resolution to be incorporated into the second portions of first objects having relatively higher rankings, wherein the format is configured to cause relatively lower levels of resolution to be incorporated into the second portions of first objects having relatively lower rankings; derive, by the computer, a period of time to retain the downloaded second portions; and in response to the predetermined amount of time elapsing, re-rank, by the computer, the first objects.

15. The computer program product of claim 9, wherein the objects are selected from the group consisting of: humans, animals, and animated characters.

16. The computer program product of claim 9, the program instructions readable and/or executable by the computer to cause the computer to: cause, by the computer, the first portions and the second portions of the first objects to be downloaded in response to a determination that the internet bandwidth is greater than the predetermined threshold.

17. A system, comprising:
a processor; and
logic integrated with the processor, executable by the processor, or integrated with and executable by the processor, the logic being configured to:
monitor eye movement of a user while the user navigates a volumetric video displayed on a user device, to establish historical data;
compare an internet bandwidth associated with the user device to a predetermined threshold; and
in response to a determination that the internet bandwidth is less than the predetermined threshold:
determine for first objects in a first view of the volumetric video, first portions of the first objects that are not visible in the first view and second portions of the first objects that are visible in the first view, cause the first portions of the first objects to be not downloaded,
cause the second portions of the first objects to be downloaded,
determine based on the historical data, levels of resolution to incorporate into the second portions in the volumetric video, and
cause the second portions, each having a respective one of the determined levels of resolution, to be incorporated into the volumetric video.

18. The system of claim 17, the logic being configured to: in response to determining that the internet bandwidth is less than the predetermined threshold: predict based on the historical data, a change of directional movement associated with the user's viewing of the volumetric video; determine for second objects predicted to be in a second view of the volumetric video that results from the change of directional movement, first portions of the second objects that are not visible in the second view and second portions of the second objects that are visible in the second view; cause the first portions of the second objects to be not downloaded; and cause the second portions of the second objects to be downloaded.

19. The system of claim 18, wherein the directional movement is selected from the group consisting of: at least some of the first objects in the video moving such that one or more of the second portions of the first objects become no longer visible, at least some of the first objects in the video moving such that one or more of the first portions of the first objects become visible, the user inputting a command associated with changing from the first view to the second view of the volumetric video, and a change in a focus of the user.

20. The system of claim 18, the logic being configured to: in response to determining that the internet bandwidth is less than the predetermined threshold: determine third portions of the first objects that are not visible in the second view and fourth portions of the first objects that are visible in the second view; cause the third portions of the first objects to be not downloaded; and cause the fourth portions of the first objects to be downloaded.
